(19) United States
(12) Patent Application Publication
(10) Pub. No.: US 2023/0380019 A1
(43) Pub. Date: Nov. 23, 2023

(54) Heating Cable Splice For Heated Floor Membrane

(71) Applicant: Appleton Grp LLC, Rosernont, IL (US)

(72) Inventors: Ben Shoemaker, Mount Forest (CA); Erik Stephens, Listowel (CA); Saeid Khavandi, Elora (CA); Andrew J. Donlan, Hamilton (CA); Paul E. Mazur, Kitchener (CA)

(21) Appl. No.: 17/746,518

(22) Filed: May 17, 2022

(51) Int. Cl. H05B 3/56

(52) U.S. Cl. CPC H05B 3/56

(57) ABSTRACT

A heating cable splice having two bulges interspersed between three sections of the heating cable splice having a smaller width than a width of the two bulges, wherein first, second, third, fourth, and fifth sections of the heating cable splice are adapted to receive electrical cabling therein, and wherein the heating cable splice is adapted to be positioned between upwardly extending bosses on a base membrane. A heating cabling system and method of providing a method of forming a heating cabling system is also disclosed.

### FIELD

The present disclosure relates to the field of heated membranes and associated electrical components. More particularly, the present disclosure is directed to heating cables for use with heated floor membranes or in-wall membranes.

### BACKGROUND

Electrical in-floor and in-wall heating installations are commonly used in residential and commercial buildings. In many of these applications, a heating cable is installed in conjunction with a base membrane, where the heating cable is secured between bosses that protrude from the base membrane. One advantage of these installations is low installation thickness. Since the heating cable is secured in-between the extending bosses, the installation thickness is limited to the height of the base membrane, extending bosses, but also the electrical components of the heating cable. An advantage of installing heating cable between bosses extending from the base membrane is speed. The base membrane and extending bosses on the base membrane provide a method of securement of the heating cable to the base membrane that allows for easy and fast installation of the heating cable in-between the extending bosses on the base membrane.

Heated floor membranes provide for heated flooring in various applications. For example, in some bathroom applications, heated flooring is used to provide for an improved experience for occupants of a bathroom utilizing a heated flooring environment. To achieve a desired heated flooring environment, heated cables may be used to provide a heated floor surface for the occupants of a bathroom environment, as an example. The heating cables may be positioned in a base membrane or mat to hold the heated cables in a desired position in-between bosses extending from the base membrane. Other applications are also possible such as any other floors desired to be heated including kitchen and garage floors, as well as heated walls where desired.

Heating cables used in floor warming or wall heating applications are series resistive cables. Series resistive cables produces a fixed wattage per foot. The heated cable is made of a resistive element with high resistivity that heats up when electrified to provide the floor warming characteristics. Therefore, the entire length of a heated section of a cable set must be embedded in cementitious material and shall not be extended outside of the area in which it is installed. In contrast, a cold section of the cable, or cold lead, could extend from one area through and to other areas. A cold lead is made of larger gauge copper wire with low resistivity such that the cold lead does not heat up when electrified. The cold lead typically starts in a junction box inside a wall where the cold lead is connected to a source of power. From there, the cold lead extends inside electrical conduits or inside walls and is routed to the cementitious material where the cold lead and the heated section are joined together using a heating cable splice. The connection between the cold lead and the heated cable section is referred to as the hot to cold splice, commonly referred to as center splice or splice. The hot to cold splice must be installed in the same cementitious material as the heated section of the cable. Within the center splice, there may be two, three, or more separate electrical connections. These electrical connections are electrically isolated from each other and are encapsulated in a plastic mold or shrink tube. The center splice, electrical connections, and insulation bundle are typically larger in diameter than the heated section, which adds undesirable thickness to the assembly.

In addition, the base membrane and bosses extending from the base membrane are designed to fit the heated section of heating cable. However, the hot to cold splice bundle is larger than the gap between the extending bosses from the base membrane bosses and does not easily fit within the base membrane. In order to overcome this issue, installers have to cut the base membrane to create a gap between the bosses of the base membrane large enough for the center splice. This process is problematic as it takes away from some of the benefits provided by the base membrane. In particular, cutting the base membrane is time-consuming and less efficient and renders the moisture barrier characteristics of the base membrane null. Furthermore, installing the larger splice could increase the installation thickness and height, which is also undesirable.

Accordingly, it would be desirable to provide a solution to the afore-mentioned drawbacks found in current heating cable installation applications.

### SUMMARY

The present embodiments advantageously provides for the center splice to be snapped in or weaved in-between the bosses of a base membrane and eliminates the need to cut or otherwise manipulate the base membrane, thereby streamlining the process of installing the heating cable into the base membrane, and eliminating the drawbacks identified above.

The base membranes in the present embodiments are designed to accommodate the diameter of a heating cable and the center splice without the need to cut the membrane to accommodate the center splice. The gap between two adjacent bosses is very close to the diameter of the heating cable. However, this small gap does not accommodate the large center splice. The bosses in some designs are undercut to hold the heating cable in place. Other designs are offset to force the cable into a weave to secure the heating cable and center splice in place with the offset. However, the intersections of the gaps, which correspond with the center of bosses, is large enough to accommodate one electrical connection and the associated insulation material. In the present embodiments, the two, three, or more electrical connections of the center splice are staggered to each align with one of these large gaps positioned between the bosses. The center splice spans over the length of multiple bosses and has two, three or more beads or bulges. These beads or bulges are spaced appropriately to coincide with larger gaps in the membrane. Each bead or bulge encases one electrical connection. The thin sections of the center splice fit in the gap between two bosses of a base membrane and the beads or bulges fit in the larger gaps. The center splice can be snapped in or weaved into the base membrane.

The unique shape of the center splice could be achieved either using a shell that encapsulates wires and electrical connection, or addition of material such that the material encapsulates the electrical connections, and the outer shape of splice conforms to the shape of the area between the membrane bosses. The general shape of the splice may provide three equidistant bulges connected by a single channel, although in some applications less or more equidistant beads or bulges may be utilized, and spacing between the bulges is not required to be equidistant depending on the geometry of the base membrane. The distance between the centers of these beads or bulges is a multiple of the distance between the centers of two bosses on the base membrane. Each bulge encapsulates one electrical connection where channels between upwardly extending bosses on the base membrane will only accommodate wires. The outermost layer of the splice may be heat shrink tubing or other insulation material. The outer shape of the splice closely matches the outline of the gap between two bosses of the base membrane.

The present embodiments allow for the center splice to be snapped in or weaved in-between the bosses of the base membrane and eliminates the need to cut or otherwise manipulate the base membrane, thereby advantageously streamlining the installation process. As a result, the present embodiments provide for quicker installation as well as maintaining the moisture barrier characteristics of the membrane. The present embodiments also advantageously allow for low installation thickness, which is desirable.

The heating cable splice may be constructed in a number of different ways. In one embodiment, the heating cable splice may be constructed in the form of a lower shell and an upper shell, where the upper shell may be separate from, or hingedly attached to, the lower shell. Alternatively, the heating cable splice could simply use heat shrink material surrounding the heating cable connections to form the bulges. In particular, the bulges could be formed using one or more layers of heat shrink material, where the resulting heating cable splice could then be covered with a heat shrink tube surrounding the entire heating cable splice. In addition, the bulges could be formed by placing the heating cable connection between the heating cable and the cold lead into a mold, where plastic could be injection molded around the heating cable connection to the cold lead to form the bulges. Furthermore, the bulges could be formed by placing the heating cable connection between the heating cable and the cold lead into a mold, where an epoxy material could be introduced around the heating cable connection to the cold lead to form the bulges. Other methods of forming the geometric configuration of the heating cable splice and bulges are also possible.

In one aspect, a heating cable splice is provided including a first section having a first width extending to a second section having a second width greater the first width of the first section, the second section thereby forming a first bulge in the heating cable splice, a third section extending from the second section having a third width less than the second width of the second section, a fourth section extending from the third section having a fourth width that is greater than the third width of the third section, the fourth section thereby forming a second bulge in the heating cable splice, a fifth section extending from the fourth section having a fifth width that is less than the fourth width of the fourth section, wherein the heating cable splice is adapted to be positioned between upwardly extending bosses on a base membrane.

In another aspect, a heating cabling system is provided having a base membrane having a plurality of upwardly extending bosses with a gap positioned between each of the upwardly bosses, a heating cable splice including a first section having a first width extending to a second section having a second width greater the first width of the first section, the second section thereby forming a first bulge in the heating cable splice, a third section extending from the second section having a third width less than the second width of the second section, a fourth section extending from the third section having a fourth width that is greater than the third width of the third section, the fourth section thereby forming a second bulge in the heating cable splice, a fifth section extending from the fourth section having a fifth width that is less than the fourth width of the fourth section, wherein a first electrical cabling extends into the first section and a second electrical cabling extends into the fifth section, wherein the first and second bulges of the second and fourth sections are positioned within the gaps between adjacent upwardly extending bosses on the base membrane, wherein the first, third, and fifth sections are positioned between adjacent upwardly extending bosses on the base membrane, and wherein first and second electrical cabling extends between adjacent upwardly extending bosses on the base member.

In a further aspect, a method is provided of forming a heating cabling system including (i) providing a base membrane having a plurality of upwardly extending bosses with a gap positioned between each of the upwardly bosses; (ii) providing a heating cable splice having a first section having a first width extending to a second section having a second width greater the first width of the first section, the second section thereby forming a first bulge in the heating cable splice, a third section extending from the second section having a third width less than the second width of the second section, a fourth section extending from the third section having a fourth width that is greater than the third width of the third section, the fourth section thereby forming a second bulge in the heating cable splice, a fifth section extending from the fourth section of the hollow shell having a fifth width that is less than the fourth width of the fourth section; (iii) extending a first electrical cabling into the first section of the heating cable splice; (iv) extending a second electrical cabling into the fifth section of the heating cable splice; (v) positioning the first and second bulges of the second and fourth sections of the heating cable splice within the gaps between adjacent upwardly extending bosses on the base membrane; (vi) positioning the first, third, and fifth sections of the heating splice between adjacent upwardly extending bosses on the base membrane; and (vii) positioning the first and second electrical cabling between adjacent upwardly extending bosses on the base membrane.

### BRIEF DESCRIPTION OF THE FIGURES

FIG. 1A is a perspective view of heating cable splice 100.

FIG. 1B is a side view of heating cable splice 100 shown in FIG. 1A.

FIG. 1C is an end view of heating cable splice 100.

FIG. 2 is a perspective view of heating cable splice 100 with heating cabling positioned therein.

FIG. 3 is a perspective view of heating cable splice 100 with an upper shell attached to the lower shell.

FIG. 4 is a perspective view of heating cable 180 and attached heating cable splice 100 positioned over base membrane 200.

### DETAILED DESCRIPTION

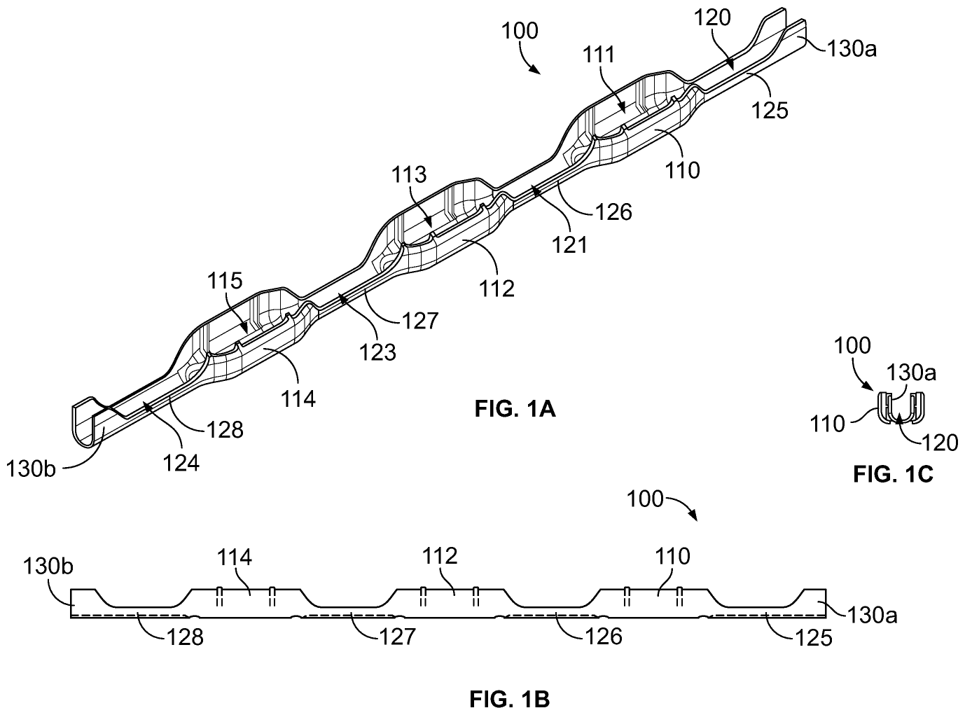

FIG. 1A is a perspective view of heating cable splice 100; FIG. 1B is a side view of heating cable splice 100 shown in FIG. 1A; and FIG. 1C is an end view of heating cable splice 100. As shown in FIGS. 1A-1C, heating cable splice 100 includes a lower hollow shell with sections of varying widths. A first section 125 having end walls 130a including an opening 120 through which heating cabling may pass through. Second section 110 having opening 111 extends from first section 125 and has a greater width than first section 125. Third section 126 having opening 121 extends from second section 110. Third section 126 has a lesser width than second section 110, and may have the same width as first section 125. Fourth section 112 having opening 113 extends from third section 121, and has a greater width than third section 126 which may have a width equal to second section 110. Fifth section 127 having opening 123 extends from fourth section 112, and has a lesser width than fourth section 112, and may have the same width as first section 125 and third section 126. Heating cable splice 100 may also include a sixth section 114 having opening 115 extending from fifth section 127. Sixth section 114 has a width greater than the width of fifth section 127, and may have a width that is equal to second section 110 and fourth section 112. A seventh section 128 having opening 124 extends from sixth section 114. Seventh section 128 has a width less than the width of sixth section 114, and may include upwardly extending walls 130b that extend around opening 124.

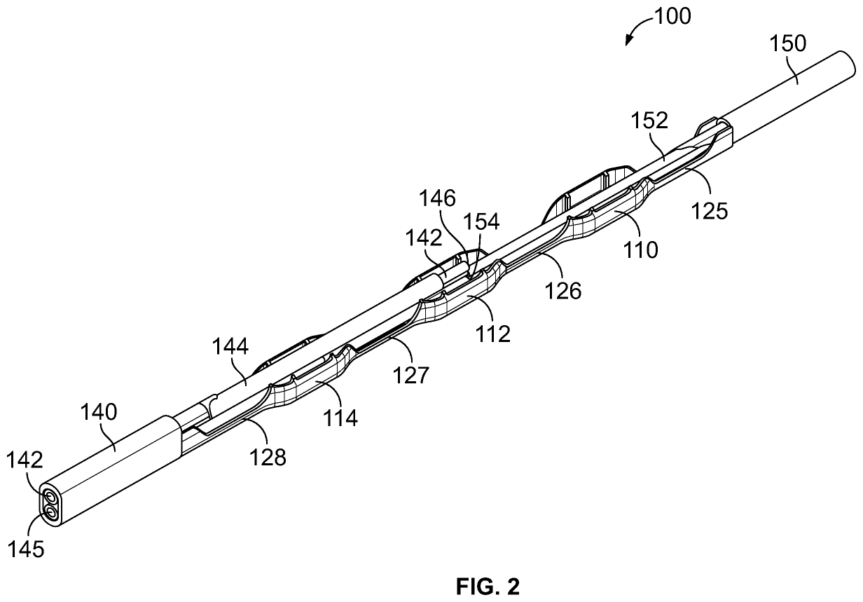

FIG. 2 is a perspective view of heating cable splice 100 with heating cabling positioned in the lower shell. First heating cable 150 has electrical wire 152 extending into first section 125, second section 110, third section 126, and into the opening in fourth section 112 of the lower shell of heating cable splice 100. In addition, second heating cable 140 housing includes electrical wires 142 and 145 that extend into seventh section 128 through sixth section 114, third section 127, and into fourth section 112 of the lower shell of heating cable splice 100. Electrical wire 142 is covered with sheath 144 where exposed electrical wire 142 has exposed end 146 and electrical wire 145 having exposed end 154 are positioned in the opening of fourth section 112. In the described manner, a heating cable splice 100 is provided for first heating cabling 150 and second heating cabling 140. It will be appreciated that, as shown, heating cable splice 100 includes three bulges in second section 110, fourth section 112 and sixth section 114, although in some application only two bulges may be used, and additional bulges may also be utilized.

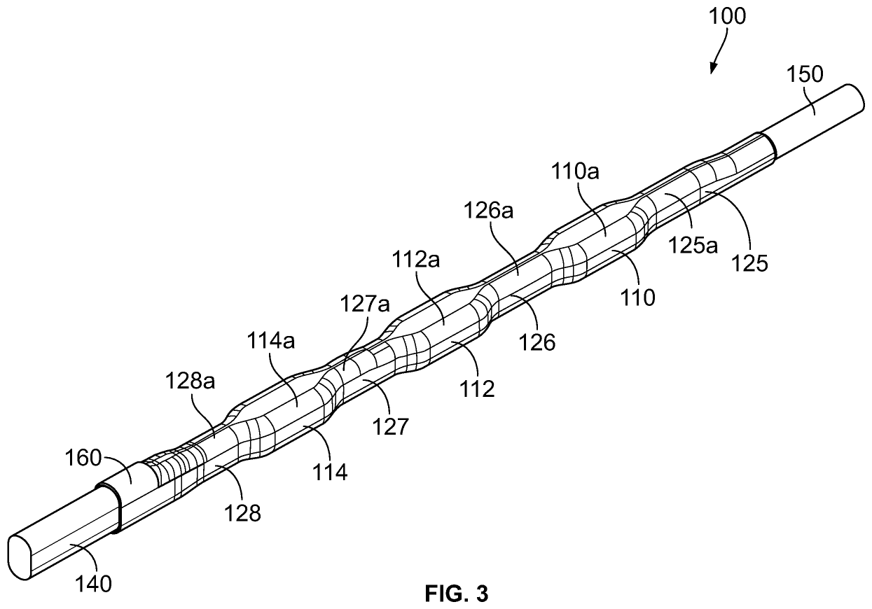

FIG. 3 is a perspective view of heating cable splice 100 with an upper shell attached the lower shell, thereby enclosing the electrical cabling extending through the heating cable splice 100. In particular, the upper shell includes upper section 125a that is secured to the first section 125 of the lower shell, includes upper section 110a that is secured to the second section 110 of the lower shell, includes upper section 126a that is secured the third section 126 of the lower shell, includes upper section 112a that is secured to the fourth section 112 of the lower shell, includes upper section 127a that is secured to the fifth section 127 of the lower shell, includes upper section 114a that is secured to the sixth section 114 of the lower shell, and includes upper section 128a that is secured to seventh section 128 of the lower shell. The upper shell also includes section 160 that extends over second heating cable 140 to secure second heating cable 140 into place.

The heating coupling splice 100 may be encapsulated in heat shrink tubing or other insulation material.

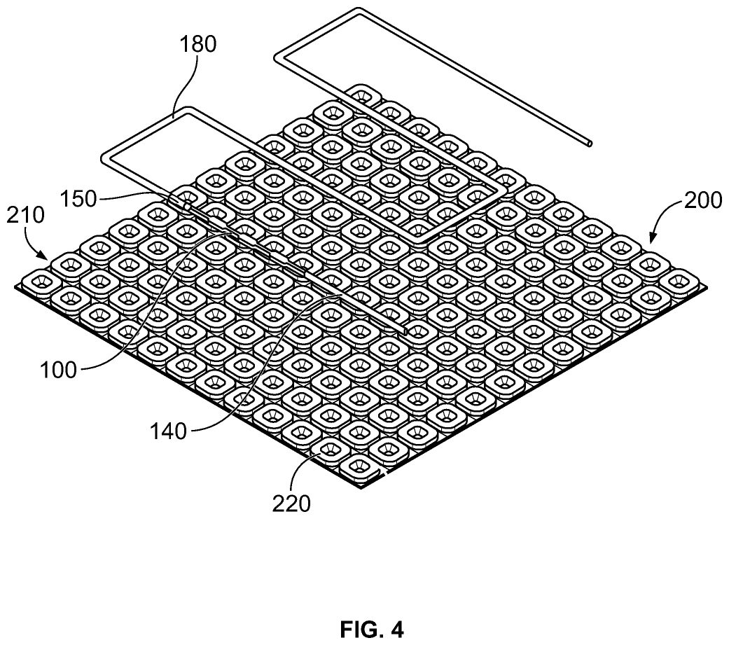

FIG. 4 is a perspective view of heating cable 180 and attached heating cable splice 100 positioned over base membrane 200. As shown in FIG. 4, heating cable 180 has end 150 that extends into a first end of heating cable splice 100, and also has heating cable 140 extending from a second end of heating cable splice 100. Base membrane 200 includes upwardly extending bosses 220 that are spaced throughout base membrane 200 with gaps 210 extending between the upwardly extending bosses 220. Heating cable 180 and heating cable splice 100 are shown positioned above base membrane 200, where they can be dropped into position in gaps 210 positioned between upwardly extending bosses 220.

FIGS. 1 and 2 disclose a heating cable splice 100 utilizing a lower shell. An upper portion over the lower shell is also shown in FIG. 3, which could be constructed in the form of an upper shell, where the upper shell may be separate from, or hingedly attached to, the lower shell. In addition, the upper portion over the lower shell could simply be constructed in the form of a heat shrink material. As noted above, rather than using a lower shell and/or an upper shell, the heating cable splice could simply use heat shrink material surrounding the heating cable connections to form the bulges. In particular, the bulges could be formed using one or more layers of heat shrink material, where the resulting heating cable splice could then be covered with a heat shrink tube surrounding the entire heating cable splice. In addition, the bulges could be formed by placing the heating cable connection between the heating cable and the cold lead into a mold, where plastic could be injection molded around the heating cable connection to the cold lead to form the bulges. Furthermore, the bulges could be formed by placing the heating cable connection between the heating cable and the cold lead into a mold, where an epoxy material could be introduced around the heating cable connection to the cold lead to form the bulges.

We claim:

1. A heating cable splice comprising:
a first section having a first width extending to a second section having a second width greater the first width of the first section, the second section thereby forming a first bulge in the heating cable splice;
a third section extending from the second section having a third width less than the second width of the second section;
a fourth section extending from the third section having a fourth width that is greater than the third width of the third section, the fourth section thereby forming a second bulge in the heating cable splice;
a fifth section extending from the fourth section having a fifth width that is less than the fourth width of the fourth section;
wherein the heating cable splice is adapted to be positioned between upwardly extending bosses on a base membrane.

2. The heating cable splice of claim 1, wherein the second section and the fourth section have the same width.

3. The heating cable splice of claim 2, wherein the first, third, and fifth sections have the same width.

4. The heating cable splice of claim 1, wherein the heating cable splice is sized to be positioned on a base membrane having a plurality of upwardly extending bosses with a gap positioned between each of the bosses.

5. The heating cable splice of claim 4, wherein the first and second bulges of the second and fourth sections are adapted to be positioned within the gaps between adjacent upwardly extending bosses on the base membrane; and
wherein the first, third, and fifth sections are adapted to be positioned between adjacent upwardly extending bosses on the base membrane.

6. The heating cable splice of claim 1, the heating cable splice is constructed using an upper shell secured to a lower shell.

7. The heating cable splice of claim 1, wherein the first and second bulges of the second and fourth sections are constructed using one or more layers of heat shrink material.

8. The heating cable splice of claim 1, wherein the first and second bulges of the second and fourth sections are constructed using injection molded plastic around electrical connections within the second and fourth sections.

9. The heating cable splice of claim 1, wherein the first and second bulges of the second and fourth sections are constructed using epoxy position around electrical connections within the second and fourth sections.

10. The heating cable of claim 1, further including a sixth section extending from the fifth section having a sixth width that is greater than the fifth width of the fifth section, the sixth section thereby forming a third bulge in the heating cable splice;
a seventh section extending from the sixth section having a seventh width that is less than the sixth width of the sixth section.

11. The heating cable splice of claim 10, wherein the first, second, and third bulges of the second, fourth, and sixth sections have the same width.

12. The heating cable splice of claim 10, wherein the first, third, fifth, and seventh sections have the same width.

13. The heating cable splice of claim 10, wherein the heating cable splice is sized to be positioned on a base membrane having a plurality of upwardly extending bosses with a gap positioned between each of the bosses.

14. The heating cable splice of claim 13, wherein the first, second, and third bulges of the second, fourth, and sixth sections are adapted to be positioned within the gaps between adjacent upwardly extending bosses on the base membrane; and
wherein the first, third, fifth, and seventh sections are adapted to be positioned between adjacent upwardly extending bosses on the base membrane.

15. A heating cabling system comprising:
a base membrane having a plurality of upwardly extending bosses with a gap positioned between each of the upwardly bosses;
a heating cable splice comprising:
a first section having a first width extending to a second section having a second width greater the first width of the first section, the second section thereby forming a first bulge in the heating cable splice;
a third section extending from the second section having a third width less than the second width of the second section;
a fourth section extending from the third section having a fourth width that is greater than the third width of the third section, the fourth section thereby forming a second bulge in the heating cable splice;
a fifth section extending from the fourth section having a fifth width that is less than the fourth width of the fourth section;
wherein a first electrical cabling extends into the first section and a second electrical cabling extends into the fifth section;
wherein the first and second bulges of the second and fourth sections are positioned within the gaps between adjacent upwardly extending bosses on the base membrane;
wherein the first, third, and fifth sections are positioned between adjacent upwardly extending bosses on the base membrane; and
wherein first and second electrical cabling extends between adjacent upwardly extending bosses on the base member.

16. The heating cabling system of claim 15, wherein the heating cable splice further includes a sixth section extending from the fifth section having a sixth width that is greater than the fifth width of the fifth section, the sixth section thereby forming a third bulge in the heating cable splice;
a seventh section extending from the sixth section having a seventh width that is less than the sixth width of the sixth section;
wherein the first, second, third, and fourth sections have the first electrical cabling positioned therein; and
wherein the fourth, fifth, sixth, and seventh sections have the second electrical cabling positioned therein.

17. The heating cabling system of claim 16, wherein the first, second, and third bulges of the second, fourth, and sixth sections have the same width; and
wherein the first, third, fifth, and seventh sections have the same width.

18. The heating cabling system heating cable splice of claim 16, wherein the first, second, and third bulges of the second, fourth, and sixth sections are positioned within the gaps between adjacent upwardly extending bosses on the base membrane; and
wherein the first, third, fifth, and seventh sections are positioned between adjacent upwardly extending bosses on the base member.

19. A method of providing a heating cabling system comprising:
providing a base membrane having a plurality of upwardly extending bosses with a gap positioned between each of the upwardly bosses;
providing a heating cable splice comprising:
a first section having a first width extending to a second section having a second width greater the first width of the first section, the second section thereby forming a first bulge in the heating cable splice;
a third section extending from the second section having a third width less than the second width of the second section;
a fourth section extending from the third section having a fourth width that is greater than the third width of the third section, the fourth section thereby forming a second bulge in the heating cable splice;
a fifth section extending from the fourth section of the hollow shell having a fifth width that is less than the fourth width of the fourth section;
extending a first electrical cabling into the first section of the heating cable splice;
extending a second electrical cabling into the fifth section of the heating cable splice;
positioning the first and second bulges of the second and fourth sections of the heating cable splice within the gaps between adjacent upwardly extending bosses on the base membrane;
positioning the first, third, and fifth sections of the heating splice between adjacent upwardly extending bosses on the base membrane; and
positioning the first and second electrical cabling between adjacent upwardly extending bosses on the base membrane.

20. The method of claim 19, wherein the heating cable splice further includes a sixth section extending from the fifth section having a sixth width that is greater than the fifth width of the fifth section, the sixth section thereby forming a third bulge in the heating cable splice, and a seventh section extending from the sixth section having a seventh width that is less than the sixth width of the sixth section;
positioning the first electrical cabling into the first, second, third, and fourth sections of the heating cable splice; and
positioning the second electrical cabling into the fourth, fifth, sixth, and seventh sections of the heating cable splice.

21. The method of claim 20, wherein the first, second, and third bulges of the second, fourth, and sixth sections have the same width; and wherein the first, third, fifth, and seventh sections have the same width.

22. The method of claim 19, further including positioning the third bulge of the sixth section of the heating cable splice between the gaps between adjacent upwardly extending bosses on the base membrane; and
positioning the seventh section of the heating cable splice between adjacent upwardly extending bosses on the base membrane.

23. The method of claim 19, wherein the heating cable splice is snapped into position between the adjacent upwardly extending bosses on the base membrane.

24. The method of claim 19, including forming the first and second bulges of the second and fourth sections of the heating cable splice by using one or more layers of heat shrink material.

25. The method of claim 19, including forming the first and second bulges of the second and fourth sections by injection molding plastic around electrical connections within the first and second bulges of the second and fourth sections.

26. The method of claim 19, including forming the first and second bulges of the second and fourth sections by positioning epoxy around electrical connections within the first and second bulges of the second and fourth sections.
